(19) United States
(12) Patent Application Publication
(10) Pub. No.: US 2024/0206479 A1
(43) Pub. Date: Jun. 27, 2024

(54) PACKAGING MATERIAL

(71) Applicant: SOREMARTEC S.A., Senningerberg (LU)

(72) Inventors: Igor ROMANO, Olm (LU); Fei LI, Singapore (SG)

(73) Assignee: SOREMARTEC S.A., Senningerberg (LU)

(21) Appl. No.: 18/555,358

(22) PCT Filed: Apr. 15, 2022
(86) PCT No.: PCT/EP2022/060176

§ 371 Date: Oct. 13, 2023

(30) Foreign Application Priority Data
Apr. 16, 2021 (LU) LU500047

(51) Int. Cl. A01N 65/36; A01N 25/10; A01N 31/02; A01N 65/22; A01N 65/24; A01N 65/28; A01P 1/00; A01P 3/00; A21D 15/08; B65D 65/42; B65D 65/46; B65D 81/26; B65D 81/28

(52) U.S. Cl. CPC A01N 65/36; A01N 25/10; A01N 31/02; A01N 65/22; A01N 65/24; A01N 65/28; A01P 1/00; A01P 3/00; A21D 15/08; B65D 65/42; B65D 65/466; B65D 81/267; B65D 81/28; B65D 2565/387

(57) ABSTRACT

A packaging material with a multi-layer structure including at least one layer for the release of an active agent with anti-microbial and/or anti-fungal activity, including the active agent in a biodegradable material, which allows its release in gas or vapor state and at least one coating layer including nanocellulose. The packaging material may include a structural substrate selected from cellulose, starch-based material, polyhydroxyalkanoate or a polybutylene succinate polymer. The packaging material may further include a coating layer with oxygen scavenging properties and a gas-barrier layer.

The present invention relates to a packaging material for food products, with antimicrobial and antifungal properties, particular with mould-growth inhibiting properties.

More particularly, the invention relates to a material in the form of a film or sheet for use in “active” packaging systems, capable of inhibiting the growth of microorganisms on the surface of the food product packaged therein.

In relation to active packaging systems, EP 3 569 644 describes a packaging material comprising a base layer (core layer) of polymeric material including anti-microbial or anti-mould substances (dispersed in the polymer), a coating formed by a polymeric lacquer or varnish including phyllosilicate or hydrotalcite nanofillers applied to one face of the base layer and a coating constituting an active release system for an antimicrobial and/or antifungal agent applied to the other face of the core layer, comprising encapsulated ethanol and a polymeric component and optionally a coating layer with oxygen scavenging activity.

An object of the present invention is to provide an improved packaging film or sheet for the realization of active packages which is able to inhibit or delay the growth of microorganisms, fungi and molds on food products both in the case in which the food product is in a close contact with the packaging material and in the case in which there is a head space between the product and the wrapping formed by this material.

Another object of the invention is to provide a packaging sheet or film which allows to achieve a prolonged and controlled release of the anti-microbial and antifungal agents' vapor into the head space of a package made from said packaging material.

Another object of the invention is to provide a packaging material with improved eco-sustainability characteristics.

### SUMMARY OF THE INVENTION

In view of the above-mentioned purposes, the subject-matter of the invention is a multilayer sheet packaging material, having the characteristics defined in the appended claims.

Another object of the invention is a package which includes a food product, particularly a bakery product, a chilled product or a confectionery product made by the aforementioned packaging material or comprising such material.

The multi-layer sheet packaging material according to the invention comprises:
a) at least one layer for the release of an active agent having antimicrobial and/or antifungal activity, comprising said active agent dispersed or dissolved in a biodegradable polymeric material which releases it in the vapor or gas state and
b) at least one coating layer comprising nanocellulose, said coating layer b) having a nanocellulose content of at least 60 wt %, preferably of at least 80 wt % most preferably at least 90 wt % up to 100 wt %.

When the nanocellulose content in said coating layer is less than 100 wt %, the balance to 100 wt % may comprise water, a polymeric material, preferably a polyacrylic polymer, a PHA or PBS, a filler such as montmorillonite (MMT) or LDH (hydrotalcite) and/or an active agent having antimicrobial or antifungal properties or a mixture combining one or more of the herein cited components . . . .

Water, typically resulting after drying or partially drying the water-based solution comprising nanocellulose that is used for applying the coating layer, may be in the range of from 1 to 10 wt % referred to the weight of the coating layer.

The above-mentioned polymers (PHA, PBS or polyacrylic) may be in the range of from 0 to 40 wt %, or from 5 to 35 wt % referred to the weight of the coating layer.

Fillers (MMT or LDH), when used, may be present in the range up to 10 wt %, referred to the weight of the coating.

Active agents that can be used in the nanocellulose coating layer, optionally in combination with said polymers and/or fillers may be in the range of from 0.1 to 6 wt %.

In an embodiment, the nanocellulose coating, having the above-mentioned content, or the mentioned preferred nanocellulose contents, includes 1 to 8 wt % water, the balance to 100% being PHA and/or PBS.

According to the invention, the packaging sheet comprises c) a structural substrate (i.e. the substrate which gives the sheet the mechanical properties suitable for use as a packaging sheet) comprising, consisting essentially of, or consisting of a material selected from the group consisting of a cellulose-based material (such as paper, cellophane, paperboard or cardboard), a polyhydroxyalkanoate (PHA), polybutylene succinate (PBS) or their co-polymers, poly(ε-caprolactone) (PCL) and a starch-based material optionally including a biodegradable polymer such as aliphatic polyesters or aliphatic-aromatic polyesters, and mixtures thereof.

In one embodiment, the aforementioned at least one layer for the release of an active agent is the aforementioned structural substrate and the active agent (or a mixture of active agents) is dispersed or dissolved in the above mentioned biodegradable polymeric materials or in a mixture thereof.

In another embodiment, which however does not exclude the aforementioned embodiment, but which can be carried out in combination with the aforementioned embodiment, the at least one layer for the release of an active agent is an additional coating layer, distinct from the structural substrate.

The layer comprising nanocellulose b) can be a coating layer applied onto one or both sides of the substrate in direct contact with one or both of its faces, or, optionally, not in direct contact and therefore with the interposition of one or more further coating layers, as described below.

When the aforesaid layer for the release of an active agent a) is an additional coating not constituting the structural substrate of the packaging, it is preferably applied as a surface coating layer on the side of the packaging that in use is intended to be facing inwards, that is facing the product contained in the package.

Further characteristics and advantages of the sheet packaging material object of the invention will become clear from the detailed description that follows, made with reference to the attached drawings, provided by way of non-limiting example.

### BRIEF DESCRIPTION OF THE DRAWINGS

In the attached drawings:

FIG. 1 is a schematic sectional representation of a first embodiment of the packaging material according to the invention used in working examples 1-3;

FIGS. 2 and 3 are schematic representations of alternative embodiments; FIG. 2 is a schematic sectional representation of an alternative embodiment of the packaging material used in working examples 4-5; FIG. 3 is a schematic sectional representation of an alternative embodiment of the packaging material used in working example 6;

FIG. 4 is a schematic representation of the structure of the packaging material used in comparative examples 7 and 8,

FIG. 5 is a schematic representation of layer 2 used in examples 1˜4 and

FIG. 6 shows the structure of cellulose.

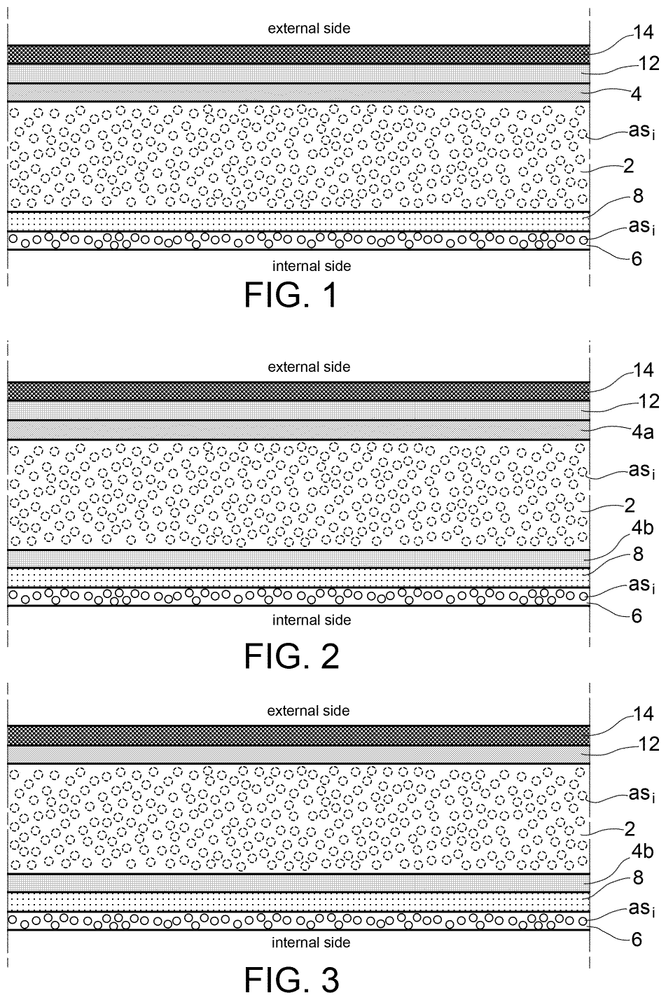

In FIGS. 2 to 4 layers corresponding to layers illustrated in FIG. 1 are indicated with the same reference numbers.

### DETAILED DESCRIPTION OF THE INVENTION

The invention relates to packaging materials for food products and was developed with particular regard to the packaging of bakery products, chilled products and confectionery products, optionally stuffed, in order to extend their “shelf-life”, particularly in relation an oxidative, microbiological and organoleptic deterioration.

One embodiment of the invention relates to a packaging material in the form of a film or sheet for making hermetically sealed packages, obtained from a single hermetically sealed sheet with hot, cold or ultrasonic sealing bands, for example of the flow pack type (see in this regard EP-A-0 957 043) or obtained with two or more wrapping sheets sealed together.

However, the packaging material in the form of a film or sheet can also be applied to the production of thermoformed packages or containers, by applying the film or sheet to a thermoformable substrate, for example for the production of FFS (Form, Fill, Seal) containers.

With reference to sealed packages, of the type mentioned above, which require the presence of a hot, cold or ultrasonic sealing material, in the sealing regions, i.e. in the regions where the edges of the sheet or wrapping sheets are overlapped and sealed, it is understood that the layered structure of the packaging material here described applies to the regions of the film or sheet which face or are in contact with the food product in the package.

In other words, the definition of film or sheet packaging material, herein provided, having a multilayer structure, including active layers or coatings, does not imply a homogeneous film or sheet material over its entire flat extension; it is, therefore understood that the multilayer structure of the packaging material herein described does not necessarily have to be present in the sealing regions of the package.

With reference to the drawings, FIG. 1 illustrates the structure of a multilayer film or sheet comprising the layers referred to in points a), b) and c) above and described in detail below.

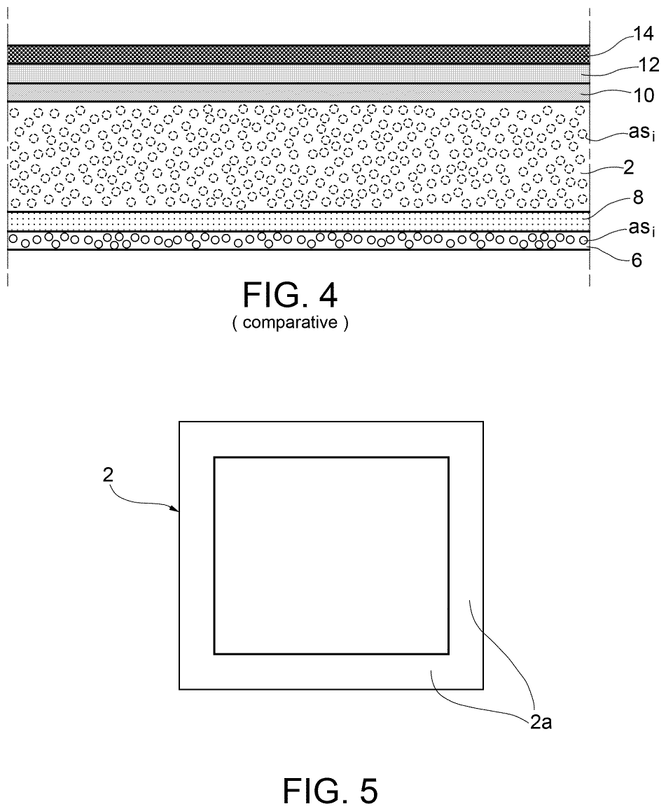

In the drawings, 2 indicates the substrate constituting the structural layer of the sheet which determines the mechanical properties of the packaging material; 4, 4a and 4b indicate a coating layer comprising nanocellulose; 6 a coating layer suitable for releasing active substances, 8 a coating layer with oxygen scavenging properties (oxygen scavenger), 12 a continuous or discontinuous printed layer, 14 an external protective layer; reference numeral 10 in FIG. 4 relating to the structure of comparative examples (not including the nanocellulose layer) indicates a gas barrier layer, which may optionally be present in the structures of FIGS. 1 to 3.

The structural substrate 2 is formed by a cellulosic material, such as paper, cellophane, paperboard or cardboard, with the desired weight, or by an extruded layer based on nanocellulose, or by a material based on polyhydroxyalkanoate, polybutylene succinate or its copolymers, poly(ε-caprolactone) (PCL), polylactic acid (PLA) with/without PLA-degrading enzyme, or starch or blends of starch with a biodegradable polymer and, optionally includes an active agent with antimicrobial and/or antifungal activity described below.

Copolymers of polybutylene succinate include poly(1,4-butylene succinate-co-adipate), poly(1,4-butylene succinate-co-1,4-butylene azelate), poly(1,4-butylene succinate-co-1,4-butylene terephthalate), poly(1,4-butylene succinate-co-1,4-butylene sebacate-co-1,4-butylene terephthalate), poly(1,4-butylene adipate-co-1,4-butylene succinate-co-1,4-butylene terephthalate), poly(1,4-butylene azelate-co-1,4-butylene succinate-co-1,4-butylene terephthalate). Also included are polyhydroxyalkanoate-polybutylene succinate copolymers.

In the case of a polyhydroxyalkanoate, polybutylene succinate, poly(ε-caprolactone) (PCL), polylactic acid (PLA) with/without PLA-degrading enzyme-based material or mixtures thereof, it can be a monolayer film or a coextruded film comprising a main layer, of greater thickness, and thinner surface layers, on one or both sides of the main layer, suitable for carrying out additional functions, for example, having characteristics of sealability or printability.

The substrate 2 can also comprise a metallized or chemical or physical vapor deposition coating on the surface which in the application of packaging will face outwards, obtained through a high vacuum metallization or chemical or physical vapor deposition process, for example with a deposit of aluminum, aluminum oxide (AlOx) or silicon oxide (SiOx).

For the substrate, the use of degradable biopolymers of poly (hydroxyalkanoate) is particularly preferred. Poly (hydroxyalkanoates) (PHA) are biodegradable polyesters, naturally produced by over 250 different bacteria, including gram-negative and gram-positive bacteria. PHAs are synthesized in the cytoplasm and stored in the form of granules.

In general, the PHAs, used in the present invention, can be represented by the general formula:

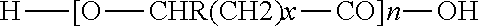

in which
R is hydrogen or an organic radical having up to 13 carbon atoms, preferably C1-C9 alkyl,
x is 1, 2 or 3, e
n is from 100 to 20,000, preferably 200 to 3,000.

Preferred are polymers and copolymers of short chain PHAs, (scl) PHA, in which the hydroxy acid has from 3 to 5 carbon atoms and medium chain PHAs, (mcl) PHAs, in which the hydroxy acid has from 6 to 10 carbon atoms, having a melting point of 50 to 170° C., preferably from 100 to 160° C. Examples of poly (hydroxyalkanoate) polyesters that can be used within the scope of the invention include, but are not limited to, poly (3-hydroxybutyrate) (3HB), poly (4-hydroxybutyrate) (4HB), poly (3-hydroxyvalerate) (3HV); Particularly preferred are copolymers of hydroxybutyrate and hydroxyvalerate or hydroxyhexanoate which have a melting temperature of 120 to 160° C. including, poly (3-hydroxybutyrate-co-3-hydroxyvalerate), poly (hydroxybutyrate-co-hydroxyhexanoate), poly (3-hydroxy-co-4-hydroxybutyrate).

According to the invention. PHAs can be processed for the production of packaging films and sheets by means of conventional thermoforming, molten extrusion or solvent casting techniques with the possible addition of active agents described below and any additives conventionally used in plastic materials. The substrate may comprise antioxidant agents (e.g. Irganox®, Irgafos®), anti-nucleating and sliding agents for plastic materials, which are preferably environmentally degradable. Furthermore, according to another aspect of the invention, the PHAs can be processed to form containers by means of injection molding and/or thermoforming techniques.

Typically, the substrate 2 is the thickest layer of the multi-layer sheet with a thickness ranging from 5 μm to 80 μm, preferably from 30 to 70 μm.

The layer 6 for releasing an active agent is a coating layer comprising a biodegradable polymeric material in which at least one active agent or a mixture thereof is dispersed or dissolved. It may be distinct from the substrate in view of its lower thickness, or in view of a different nature of the active agents or in view of a different chemical nature of the polymeric material.

The term “biodegradable material”, herein, means a material, which is degradable as a result of the action of microorganisms existing in nature such as bacteria, fungi or algae and/or natural environmental factors such as hydrolysis, transesterification, exposure to ultraviolet rays or visible light (photo-degradable) and/or enzymatic mechanisms or their combinations.

The biodegradable materials for layer 6 can be natural polymers such as polysaccharides, such as chitosan, alginates, cellulose (nanocellulose or paper), starch, or natural-derived polymers, such as the same polyhydroxyalkanoates, previously described or synthetic polymers such as the same polybutylene succinate previously mentioned for the substrate, and/or aliphatic polyesters.

The layer 6 and optionally also the substrate 2 comprise active agents with anti-microbial and/or anti-fungal activity, dispersed or dissolved in the biodegradable polymeric material, indicated with asᵢ in the annexed drawings.

Such active agents asᵢ include essential oils and their components, plant extracts, ethanol in powder or encapsulated form and their mixtures, but are not limited to them.

The active agents are preferably selected from the following and their mixtures:
Grapefruit seed extract or citrus seed extract: it is a liquid extract derived from seeds, pulp and white membranes of grapefruit or a powder form which is made from liquid extract mixed with carrier (including maltodextrin, silica or cyclodextrin, e.g. 60% by weight of grapefruit seed extract and 40% by weight of maltodextrin. It is known as a natural antimicrobial agent containing flavanones, naringin and hesperidin; naringin and/or hesperidin can also be used as active agents;
lemon zest essential oil: it is a liquid extract containing mainly limonene;
tea tree oil (Melaleuca alternifolia oil): an essential oil distilled from the tea tree, whose antiseptic, antifungal, antibacterial and antiviral properties are known; its main active component is terpinene-4-ol (about 40%);
cinnamon oil: liquid extract obtained from cinnamon leaves comprising linalool as the main component (about 36%);
thyme oil and its main components such as thymol, p-cymene, estragol, linalool and carvacrol;
ethanol powder or granules containing ethanol, dispersed in the matrix of biodegradable polymeric material. These granules, which preferably are (micro) capsules, comprise an organic solid edible carrier, consisting of an organic edible polyol such as dextrins, maltodextrins, glucose, starches, starch hydrolysis products or dextrose and have an ethanol content of 5 to 55% by weight, more preferably from 20 to 45% by weight; flowable powders with grain sizes in the range from 0.01 to 1.5 mm, more preferably from 0.03 to 0.6 mm are preferred.

These granules can be obtained by spray drying, extrusion in the molten state and spray granulation in fluidized bed.

Production processes by spray drying and/or spray granulation in fluidized bed are known from U.S. Pat. Nos. 4,454,165 and 5,961,707, incorporated herein by reference.

A typical process, described in U.S. Pat. No. 5,961,707, is carried out by spray granulation in a fluidized bed of a solution of dextrins or maltodextrins in a water/alcohol mixture.

The term “dextrins” includes starch, waxy starch, modified starch, and starch degradation products, in particular soluble in cold water.

Particularly preferred is the use of soluble dextrins or maltodextrins at a concentration of at least 40% and preferably at least 60% by weight in water at 25° C.

Solutions for the granulation process generally comprise from 20 to 70%, more preferably from 35 to 55% of dextrins, from 10 to 40%, preferably from 20 to 35% by weight of water and from 10 to 40%, preferably from 20 to 35% by weight of ethanol. In the preferred process, the solutions are spray granulated in a fluidized bed under constant stirring.

Optionally, the granules used in the present invention can be further coated with a support material that improves the encapsulation of the ethanol and delays its release, as well as giving the powders characteristics of smoothness and abrasion resistance. Suitable coating materials can be starches, cellulose, cellulose derivatives, gelatin, lactose, fats and the like with a proportion of coating material (if used) from 5 to about 30% by weight referred to the uncoated granules.

The ethanol powder used in the present invention also includes ethanol encapsulated in cyclodextrins, including α, β and/or γcyclodextrins.

In one embodiment, ethanol powder can be dispersed in nanocellulose as a biodegradable matrix or encapsulated in nanocellulose.

In one embodiment, the layer for the release of an active agent 6 comprises powdered ethanol, generally in quantities of 1 to 60% by weight, preferably from 5 to 40%, or 5 to 50% by weight, based on the weight of the biodegradable matrix

In one embodiment, the layer 6 for the release of an active agent comprises powdered ethanol and a polymeric component selected from chitosan grafted with polyethylene glycol or with cyclodextrin, and a mixture of chitosan and polyethylene glycol (PEG).

Chitosan grafted with PEG or with cyclodextrin can be obtained by processes known in the literature and described, for example, by E. V. R. Campos et al. in Front Chem. 2017, 5:93 (Doi: 10.3389/F. Chem 2017.00093) and in the literature cited therein.

According to an aspect of the invention, the release layer 6 is obtained by applying a hydrogel comprising chitosan grafted with polyethylene glycol or cyclodextrin, e.g. in quantities from 40 to 60% by weight, ethanol in powder or encapsulated, e.g. in quantities from 1 to 6% by weight and water.

In another embodiment, the layer 6 comprises powdered or encapsulated ethanol and a mixture of polyethylene glycol and chitosan; this coating is obtained by applying a solution containing chitosan, PEG and ethanol encapsulated in a solvent, such as acetyl acetate, ethyl acetate or isopropyl alcohol; aqueous solutions can also be used.

This coating may further include acetic acid or hydrochloride acid, e.g. 2%, and a surfactant up to 3% by weight. The preferred surfactant is sorbitan ethoxylate with a molar content of ethylene oxide of less than 300 moles of ethylene oxide per mole of sorbitan.

By way of example, the following printable coating compositions can be used:
i) chitosan: 25% by weight
PEG: 25% by weight
ethanol encapsulated in maltodextrin: 1% by weight
acetyl acetate solvent: 49% by weight,
or
ii) chitosan (90% deacetylation): 15% by weight
PEG: 30% by weight
ethanol in powder or encapsulated: 2% by weight
solvent: ethyl acetate or isopropyl alcohol or water at 53% by weight.

In general, the total content of PEG and chitosan is 40 to 60% by weight and the content of powdered or encapsulated ethanol is 1 to 6% by weight.

Preferably, the chitosan used having formula (C₆H₁₁O₄N)ₙ has a molecular weight from 40 to 350 kDa and different degrees of deacetylation and viscosity.

The PEG preferably used has a melting point lower than 65° C., with a viscosity at 50° C. greater than 35 mm²/s (DIN 51562) with a molecular weight lower than 20000 g/mol and preferably lower than 1000 g/mol (DIN 53240).

The amount of active agent in the layer for the release of an active agent or in the substrate may widely vary according to the substance used. In general, amounts of from 0.1 to 60% by weight, referred to the weight of the biodegradable polymeric material, may be used, preferably from 5 to 50% wt.

For liquid extracts or essential oils, quantities of 0.2% to 4% by weight, based on the weight of the biodegradable polymeric material, are preferably used.

The active agent or the mixture of active agents can be incorporated into the biodegradable polymeric material in the extrusion process according to the known extrusion techniques of a compound.

The layer 6 for the release of an active agent is preferably applied as a surface layer on the side of the packaging sheet which, in use, is facing the product; it may also be applied as a coating of the substrate 2, directly or with the interposition of a coating layer comprising nanocellulose 4, (also indicated with 4b in FIGS. 2 and 3) or with the interposition of both a coating layer comprising nanocellulose 4b and a coating layer with oxygen scavenging activity 8 (oxygen scavenging layer) (see FIGS. 2 and 3). Although layer 6 is preferably a surface layer, as indicated before, it may be coated with additional layer(s) that does(do) not interfere with or hinder the release of the active agent(s) inside the packaging.

According to the invention, the multi-layer sheet packaging material comprises at least one coating layer 4, 4a or 4b comprising or consisting of nanocellulose. The term nanocellulose includes nanocellulose modified in the CH₂OH groups, for example by esterification or amidation or etherification.

In particular, the use of cellulose nanofibers (CNF), nanocrystalline cellulose (CNC) or bacterial nanocellulose (BNC) is optionally contemplated for this layer, as indicated above.

The nanocellulose layer 4, 4a or 4b may optionally include active agent(s) asᵢ as described before.

The combination of a nanocellulose coating with an active agent release layer (whether it consists of the aforementioned substrate 2 or the coating layer 6 or both) comprising volatile or semi-volatile active agents or capable of releasing active volatile vapors, results in a significant increase of the biocidal properties of the packaging sheet and therefore leads a prolonged shelf life of the product packaged therein, presumably thanks to a sustained release over time in the head space of the package.

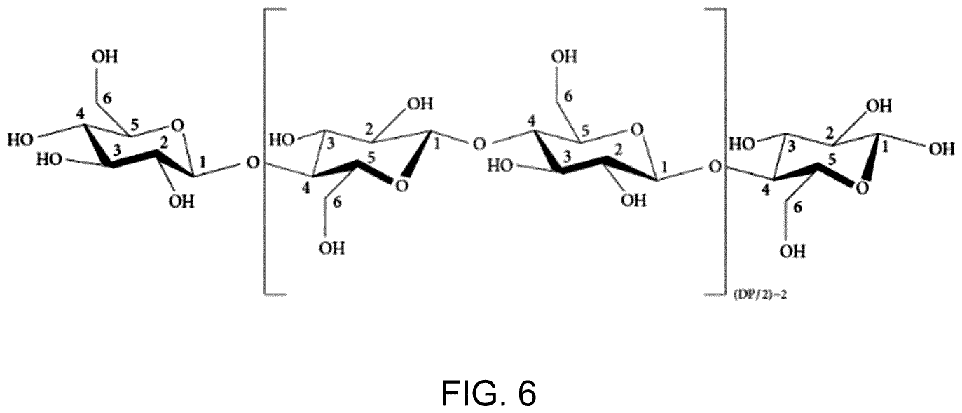

The coating layer or layers comprising nanocellulose also impart both oxygen and water vapor barrier properties to the sheet; for this purpose, the use of CH₂OH group-modified (usually at C6 site in cellulose chemical structure, indicated in FIG. 6) nanocellulose is preferred, as indicated.

Coatings comprising nanocellulose, preferably CNC, mixed with hydrotalcite or montmorillonite can also be used.

In the embodiment of FIG. 1, a coating layer 4 comprising nanocellulose is directly applied to the substrate 2 on the opposite side with respect to layer 6.

In the embodiment of FIG. 2, two nanocellulose coating layers 4a and 4b are provided arranged on the opposite side with respect to the substrate 2.

In the embodiment of FIGS. 2 and 3, a nanocellulose coating layer 4b is directly applied to the substrate 2 interposed between the substrate 2 and an oxygen scavenging coating layer 8 on the part of the substrate that in use is intended to face the packaged product.

The layer comprising nanocellulose can be applied by conventional coating processes, for example, by means of a helical cylinder, flexographic printing or rotogravure printing.

The thickness of layer 4 is preferably from 0.5 to 10 μm.

According to an optional but preferred embodiment, the multi-layer sheet comprises at least one coating layer 8 having oxygen scavenging activity suitable for reducing the oxygen concentration in the head space of the package made with the packaging material according to the invention. This layer 8 may be an intermediate layer between the substrate 2 and the layer 6 for the release of an active agent (FIG. 1); however, as illustrated in FIG. 3, the layer 8, when adopted, can also be arranged between the layer 6 and a layer comprising nanocellulose 4b.

In one embodiment, the oxygen scavenging coating layer 8 may be obtained by a solution comprising meso-porous silica, ethylene vinyl alcohol (EVOH), iron, sodium ascorbate and/or sodium chloride in an organic solvent or water, with solvent or water removal.

In one embodiment, the oxygen scavenging coating layer 8 can comprise iron and/or sodium ascorbate and/or silica and can be obtained by applying a solution or suspension comprising one or more of them, in water, an organic solvent, or in a biodegradable lacquer.

In another embodiment, it is possible to use an oxygen scavenging coating of an enzymatic nature (such as containing catalase).

This coating layer 8 can have a coating weight greater than 0.3 g/m² and generally less than 10 g/m².

Optionally, the multi-layer sheet further comprises a coating layer 10 having gas barrier properties, preferably having an oxygen transmission rate of less than 0.2 mL/(m²·day·atm) at 23° C. and 0% relative humidity. In the practical application of the packaging material, this coating is preferably applied on the part of the sheet intended to face the outside of the package. Although optional layer 10 is not shown in FIGS. 1 to 3, it may be applied as a coating of the layer 4 or 4a comprising nanocellulose in the structures of FIGS. 1 and 2 or as a coating of the substrate 2 in the structure of FIG. 3, which is on the side of the substrate opposite with respect to the food product packaged therein.

The barrier coating layer 10 may be obtained with the use of a varnish or polymeric lacquer, in a solvent or without solvent, including fillers of a phyllosilicate/montmorillonite (nano clay), of graphene or oxidized graphene, of artificial mica, or of LDH (e.g. hydrotalcite), preferably in an amount from 3 to 30% by weight referred to weight of the lacquer or varnish, with solvent removal, if used. The use of montmorillonite fillers with a length less than 1 μm is preferable. This lacquer or varnish preferably comprises a biodegradable polymeric component such as ethylene vinyl alcohol (EVOH), poly (vinyl alcohol) (PVOH), starch or nanocellulose or mixtures thereof.

Typically, the barrier layer 10 has a weight (dry residue) greater than 0.4 g/m² and less than 5.0 g/m², more preferably less than 2.5 g/m².

The coating can be applied by various technologies such as flexographic printing, gravure printing or other known film coating technologies.

The barrier layer 10 described above is also capable of achieving an adequate level of water vapor barrier, with a transmission rate that can reach values of less than 0.2 g/(m² day) in tropical conditions (38° C.; 90% relative humidity).

The surface of the sheet material, facing outwards preferably has a protective coating 14 consisting of a varnish optionally comprising anti-microbial active substances including silver ions, copper ions, ZnO particles, quaternary siloxane and/or (modified) poly(vinyl alcohol) with positive charges (namely polycationic substances).

Reference numeral 12 indicates an optional continuous or discontinuous printed layer resulting from the application of printing inks (e.g. an ethyl-acetate-based printing ink), applied e.g. by rotogravure, which may be an outer layer or may be covered by a protective layer 14.

### WORKING EXAMPLES

The following examples refer to preferred embodiments of the invention.

Comparative examples are provided to highlight the technical effect of the invention; they are not to be construed as illustrating the state of the art.

### Example 1

A packaging film with a layered structure comprised of the following layers (FIG. 1).
Layer 14: a protective varnish consisting of 1 wt % quaternary siloxane in a 99 wt % polyurethane-based matrix as an external coating, with coating weight 2 g/m².
Layer 12: ethyl acetate-based printing ink with total coating weight 10 g/m² applied by rotogravure printing.
Layer 4: nanocellulose layer comprising 93 wt % nanocellulose (cellulose nanocrystals) and 7 wt % moisture, with coating weight 1 g/m².
Layer 2: 25 μm metallized bi-oriented bio-based polybutylene succinate packaging film with sealing initiation temperature (SIT) at 50 m/min. of 70° C.
Layer 8: an oxygen scavenging coating comprising 10 wt % iron, 80 wt % silica and 10 wt % ethylene vinyl alcohol with coating weight 10 g/m².
Layer 6: a coating for the release of active agents comprising 48 wt % chitosan, 48 wt % PEG, 2 wt % ethanol encapsulated in maltodextrin and 2 wt % water with coating weight 5 g/m².

### Example 2

Packaging film having the same layered structure and composition of Example 1, but not including the external coating layer 14.

### Example 3

Packaging film having the same layered structure and composition of Example 1, wherein layer 2 is a metallized bi-oriented bio-based polybutylene succinate packaging film including 3 wt % nanocellulose (cellulose nanocrystals) well dispersed into the polybutylene succinate film.

### Example 4

Packaging film comprising the following layers (FIG. 2).
Layer 14: a protective varnish comprising 3 wt % ZnO (Zinc oxide) particles as an external coating with coating weight 2 g/m².
Layer 12: the same as in Example 1.
Layer 4a: barrier coating is comprised by 93 wt % nanocellulose (cellulose nanocrystals) and 7 wt % moisture with coating weight 1 g/m².
Layer 2: 25 μm metallized bi-oriented bio-based polyhydroxyalkanoate packaging film with sealing initiation temperature (SIT) at 50 m/min. of 85° C.
Layer 4b: nanocellulose layer with anti-mould substances, consisting of 90 wt % nanocellulose (cellulose nanocrystals), 5 wt % grapefruit seed extract and 5 wt % water, with coating weight 1 g/m².
Layer 8: an oxygen scavenging coating comprising 10 wt % iron, 80 wt % silica and 10 wt % ethylene vinyl alcohol with coating weight 10 g/m².
Layer 6:
a coating for the release of an active agent comprising 48 wt % chitosan, 48 wt % PEG, 2 wt % ethanol and 2 wt % water encapsulated in maltodextrin, with coating weight 5 g/m².

### Example 5

Packaging film having the same layered structure of Example 4, wherein layer 2 also comprises 5% of grapefruit extract as active substance.

### Example 6

Packaging film comprising the following layers (FIG. 3).
Layer 14: a protective varnish comprising 1 wt % silver ion particles as an external coating, with coating weight 2 g/m².
Layer 12: the same as in Example 1.
Layer 2: 25 μm metallized bi-oriented bio-based polyhydroxyalkanoate-polybutylene succinate copolymer packaging film with sealing initiation temperature (SIT) at 50 m/min. of 80° C.
Layer 4b:
nanocellulose layer with anti-mould substances consisting of 95 wt % nanocellulose (cellulose nanocrystals), 5 wt % lemon peel essential oils and 5 wt % water with coating weight 1 g/m².
Layer 8: an oxygen scavenging coating comprising 10 wt % iron, 80 wt % silica and 10 wt % ethylene vinyl alcohol with coating weight 10 g/m².
Layer 6: a coating for the release of active agents comprising 48 wt % chitosan, 48 wt % PEG, 2 wt % ethanol and 2 wt % water encapsulated in maltodextrin with coating weight 5 g/m².

### Example 7 (Comparative)

A packaging film having the following layered structure (FIG. 4):
Layer 14: the same as in Example 1.
Layer 12: the same as in Example 1.
Layer 10: barrier coating based on LDH, coating weight 1 g/m².
Layer 2: the same as in Example 1.
Layer 8: an oxygen scavenging coating comprising 10 wt % iron, 80 wt % silica and 10 wt % ethylene vinyl alcohol, with coating weight 10 g/m².
Layer 6: a coating for the release of active agents comprising 48 wt % chitosan, 48 wt % PEG, 2 wt % ethanol and 2 wt % water encapsulated in maltodextrin with coating weight 5 g/m².

### Example 8 (Comparative)

A packaging film having the same layered structure and composition of Example 7, wherein layer 2 is a 25 μm bi-oriented polypropylene packaging film, with a sealing initiation temperature (SIT) of 160° C. at 50 m/min.

### Example 9

A packaging film with the same layered structure of Example 1, wherein layer 4 comprises 60 wt % nanocellulose, 7 wt % moisture, the balance to 100% being a PHA polymer.

### Example 10

A packaging film with the same layered structure of Example 1, wherein layer 4 comprises 68 wt % nanocellulose, 7 wt % moisture, the balance to 100% being a PBS polymer.

### Example 10 bis

A packaging film with the same layered structure of Example 1, wherein layer 4 comprises 80% wt % nanocellulose, 7 wt % moisture, the balance to 100% being a PHA polymer.

### Example 11 (Comparative)

A packaging film with the same layered structure of Example 1, wherein layer 4 comprises 5 wt % nanocellulose, 7 wt % moisture, the balance to 100% being a PHA polymer.

### Example 12 (Comparative)

A packaging film with the same layered structure of Example 1, wherein layer 4 comprises 15 wt % nanocellulose, 7 wt % moisture, the balance to 100% being a PBS polymer.

### Example 13

A packaging film with the same layered structure of Example 4, wherein layer 4b comprises 80 wt % nanocellulose, 5 wt % grape fruit seed extract, 7 wt % moisture, the balance to 100% being a PHA polymer.

### Example 14 (Comparative)

A packaging film with the same layered structure of Example 4, wherein layer 4b comprises 5 wt % nanocellulose, 5 wt % grape fruit seed extract, 5 wt % moisture, the balance to 100% being a PHA polymer.

### Example 15 (Comparative)

A packaging film with the same layered structure of Example 4, wherein layer 4b comprises 10 wt % nanocellulose, 5 wt % grape fruit seed extract, 5 wt % moisture, the balance to 100% being a PBS polymer.

### Storage

With the use of the packaging films according to the above examples, flow-pack packages were prepared made with a film of dimensions 155 (Length)×160 (width) mm, sealed by four borders:
Effective packaging volume: 240 cm3.

In all examples, on layer 2, four borders 2a (width 1-2 cm) are reserved for sealing areas where there are no coatings, as shown in FIG. 5.

In flow-pack packagings, a piece of bread weighing 25 g (volume 180 cm3) was introduced with water activity (Aw) greater than 0.8.
Head space volume: 60 cm3.

In order to evaluate the shelf life on the packages, they were placed in a closed environment with relative humidity of 60% and subjected to thermal cycling at 20° C. for 12 hours and 28° C. for 12 hours.

The following parameters were determined:
Water activity (Aw): is the partial vapor pressure of water in a substance divided by the standard state partial vapor pressure of water, which reflects how much the free water can be utilized by microorganisms.
Shelf life: Bread with good quality without any visible mould growth.

The results obtained are summarized in table 1, where the mean values of the above parameters are shown, obtained on three samples. The table also shows the parameters:
WVTR: water vapor transmission rate [g/(m²×24 h 90% RH; 38° C.)]
O2TR: oxygen transmission rate [cm3/(m²×24 h×atm 0% RH; 23° C.)]

Table 1 also provides the Aw at the beginning and at the end of the shelf life tests.

TABLE 1

| | WVTR | O2TR | | | Shelf- |
|---|---|---|---|---|---|
| | [g/(m² × | [(cm³/(m² × | SIT | | life |
| | 24 h)] | 24 h × atm)] | (° C.) | Aw | (days) |
| Example 1 | 5 | 0.8 | 70 | 0.83→0.77 | 110-130 |
| Example 2 | 5 | 0.8 | 70 | 0.83→0.77 | 110-130 |
| Example 3 | 1 | 0.5 | 80 | 0.83→0.80 | 150-170 |
| Example 4 | 3 | 0.3 | 120 | 0.83→0.79 | 160-190 |
| Example 5 | 3 | 0.3 | 120 | 0.83→0.79 | 180-210 |
| Example 6 | 3 | 0.5 | 100 | 0.83→0.79 | 150-180 |
| Example 7* | 5 | 1 | 70 | 0.83→0.77 | 90-100 |
| Example 8* | 6 | 10 | 150 | 0.83→0.74 | 40 |
| Example 9 | 5 | 1.8 | 70 | 0.83→0.77 | 70-80 |
| Example 10 | 5 | 1.4 | 70 | 0.83→0.77 | 80-90 |
| Example 10bis | 5 | 1 | 80 | 0.83→0.77 | 90-100 |
| Example 11* | 6 | 5 | 120 | 0.83→0.79 | 50 |
| Example 12* | 6 | 4 | 120 | 0.83→0.79 | 60 |
| Example 13 | 4 | 0.55 | 100 | 0.83→0.79 | 140-170 |
| Example 14* | 5 | 1.6 | 70 | 0.83→0.77 | 80-90 |
| Example 15* | 6 | 1.2 | 150 | 0.83→0.74 | 90-100 |

*comparative

1. A packaging material with a multi-layer structure comprising:
at least one layer for the release of an active agent with antimicrobial and/or antifungal activity, comprising said active agent dispersed or dissolved in a biodegradable polymeric material, selected from the group consisting of a polysaccharide, polyhydroxyalkanoates and polybutylene succinate and mixtures thereof, and
at least one coating layer comprising nanocellulose, having a nanocellulose content of at least 60 wt %.

2. The packaging material of claim 1, wherein said at least one coating layer comprising nanocellulose further comprises water or a polymer selected from polyhydroxyalkanoates, polybutylene succinate and polyacrylic polymers and mixtures thereof or a filler selected from hydrotalcite and montmorillonite and mixtures thereof, or an active agent having antimicrobial or antifungal properties, and wherein the nanocellulose content together with a content of said water, polymer, filler or active agent sum up to 100 wt % of said at least one coating layer.

3. The packaging material of claim 1, comprising a structural substrate comprising or consisting of a material selected from the group consisting of a cellulose material, a polyhydroxyalkanoate, polybutylene succinate or their co-polymers, poly(ε-caprolactone) (PCL), and a starch-based material optionally including a biodegradable polymer selected from the group consisting of aliphatic polyesters or aliphatic-aromatic polyesters, and mixtures thereof, said structural substrate optionally including said active agent or a mixture thereof and wherein said at least one coating layer comprising nanocellulose is applied as a coating to at least one face of the structural substrate and said layer for the release of the active agent is a surface layer of the packaging material on its side that, in use, is intended to face a product to be packaged in said packaging material.

4. The packaging material of claim 1, wherein said active agent included in said at least one layer for the release of the active agent and/or in said structural substrate is selected from the group consisting of grapefruit seed extract, lemon zest or limonene essential oil, tea tree oil, cinnamon oil, thyme oil, ethanol powder and mixtures thereof.

5. The packaging material of claim 4, wherein said active agent is contained in said at least one layer for the release of the active agent and/or in said structural substrate in quantities from 1 to 60% by weight referring to a weight of the biodegradable polymeric material.

6. The packaging material of claim 1, wherein said at least one layer for the release of the active agent comprises ethanol powder and a biodegradable polymeric component selected from chitosan grafted with polyethylene glycol or with cyclodextrin, and a mixture of chitosan and polyethylene glycol.

7. The packaging material of claim 1, wherein said at least one coating layer comprising nanocellulose comprises cellulose nanofibers (CNF), crystalline nano cellulose (CNC) or bacterial nanocellulose (BNC) optionally modified in CH₂OH groups, by esterification, amidation or etherification and mixtures thereof.

8. The packaging material of claim 7, wherein said at least one coating layer comprising nanocellulose includes an anti-microbial agent.

9. The packaging material of claim 1, further comprising a coating layer having oxygen scavenging properties adapted to reduce oxygen concentration in a head space of a package made with the packaging material.

10. The packaging material of claim 9, wherein said coating layer with oxygen scavenging properties is obtained from a biodegradable lacquer including iron or iron oxide and silica.

11. The packaging material of claim 9, wherein said coating layer with oxygen scavenging properties is obtained from a solution comprising meso-porous silica, poly (ethylene vinyl alcohol) (EVOH), iron, sodium ascorbate and optionally sodium chloride in an organic solvent or water.

12. The packaging material of claim 9, wherein said coating layer with oxygen scavenging properties is interposed between the structural substrate and said at least one layer for the release of the active agent.

13. The packaging material of claim 1, further comprising a barrier coating layer obtained with use of a varnish or polymeric lacquer, in a solvent or without solvent, including fillers of a phyllosilicate or of hydrotalcite, in an amount from 3 to 30% by weight referred to weight of the varnish or polymeric lacquer.

14. The packaging material of claim 13, wherein said varnish or polymeric lacquer comprises a biodegradable polymeric component selected from the group consisting of poly (ethylene vinyl alcohol) (EVOH), poly (vinyl alcohol) (PVOH), starch and nanocellulose and mixtures thereof.

15. The packaging material of claim 1, wherein in said at least one layer for the release of the active agent, the biodegradable polymeric material is a poly (hydroxyalkanoate) selected from the group consisting of poly (3-hydroxybutyrate) (3HB), poly (4-hydroxybutyrate) (4HB), poly (3-hydroxyvalerate) (3HV), poly (3-hydroxybutyrate-co-3-hydroxyvalerate), poly (hydroxybutyrate-co-hydroxyhexanoate), poly (3-hydroxy-co-4-hydroxybutyrate) and mixtures thereof.

16. The packaging material of claim 1 comprising:
a structural substrate optionally including an active agent with antimicrobial and/or antifungal activity,
said at least one coating layer comprising nanocellulose, applied to one or both sides of said structural substrate,
said at least one layer for the release of the active agent, applied as a surface layer on a side of the packaging material intended to face a packaged product or optionally coated, on its side facing the packaged product, with additional layer(s) that does(do) not interfere with or hinder the release of said active agent inside a package, and
a coating layer with oxygen scavenging properties for reducing oxygen concentration in a head space of the package, applied as an intermediate layer between said at least one layer for the release of the active agent and said structural substrate or between a coating layer comprising nanocellulose, when applied to said structural substrate, on its side facing the packaged product and said at least one layer for the release of the active agent.

17. The packaging material of claim 16, further comprising a coating layer with gas-barrier properties, applied as a coating of said structural substrate or as a coating of said coating layer comprising nanocellulose on a side of the packaging material that in use is opposite with respect to the product packaged therein.

18. The packaging material of claim 16, further comprising a protective coating comprising an anti-microbial substance selected from silver ions, copper ions or ZnO particles as an external coating layer.

19. A package comprising a food product, particularly a bakery product, a chilled product or a confectionery product, in a packaging material as set forth in claim 1.

20. The packaging material of claim 1, wherein said polysaccharide is selected from chitosan, alginates, starch, nanocellulose and mixtures thereof.
